(19) United States
(12) Patent Application Publication
(10) Pub. No.: US 2017/0177577 A1
(43) Pub. Date: Jun. 22, 2017

(54) BIASING SCRUBBER FOR DIGITAL CONTENT

(71) Applicant: Google Inc., Mountain View, CA (US)

(72) Inventors: Matthew Sharifi, Zurich (CH); Jakob Nicolaus Foerster, Oxford (GB)

(21) Appl. No.: 14/975,320

(22) Filed: Dec. 18, 2015

(51) Int. Cl. G06F 17/30; G06F 3/0486

(52) U.S. Cl. CPC G06F 17/3053; G06F 3/0486; G06F 17/30528; G06F 17/30595; G06F 17/30554

(57) ABSTRACT

A digital content server provides bias scores used for biasing display of sections of a digital content item, such as an e-book, audio track, or video, during scrubbing on a client device. For each user, the server compiles a user profile which includes information such as the user's search and browsing history, stated interests, and location. The server determines a collection of similar user profiles and analyzes them to determine a relevance score for each section of the digital content item. For each section, the server also identifies individual entities, and compares the identified entities against the user profile to determine a second relevance score. The server combines the relevance scores to determine an aggregate bias score for each section of the digital content item. The bias scores are provided to a client device containing a scrubber module, which uses the scores to bias display of sections during scrubbing.

### FIELD OF ART

The present invention generally relates to biasing display of sections of a digital content item for display to a user while moving through the content item (known as “scrubbing”).

### BACKGROUND

Digital content items such as videos, audio tracks, and electronic books (or “e-books”) are typically configured to allow users to rapidly navigate from one location in the content item to another. This is usually enabled by a scrubber bar, which the user can drag forward and backward through the content item. In the case of an e-book, the device or application on which the e-book is displayed features page turn buttons. By using these buttons, the user may navigate from one page to the next.

The task of navigating through a digital content item is significantly more difficult when the item is large. Videos with many frames (such as a feature-length film), long audio tracks, and multi-volume e-books are all composed of many discrete sections (whether pages or frames, etc.). Scrubber bars, page navigation buttons, and fast-forward and rewind buttons, as typically implemented, are all very crude tools for finding a particular location within a digital content item. In some cases, available readers for electronic documents may provide tools for jumping ahead a predetermined number of pages. However, jumping ahead a fixed number of pages in an electronic document is not a good electronic version of browsing. There is no assessment of the page upon which the reader lands suggesting that that page is more likely to catch the reader's eye as opposed to any other page. For example, the page displayed after jumping ahead may be the middle of an article which is not a page on which a user would stop browsing in a physical document. The task of navigation is even more difficult in other types of media such as audio and video. A user wishing to navigate to a specific location in a content item is only able to navigate to within its general vicinity, often because multiple sections of a digital content item map to a single location of the scrubber bar or button. The difficulty of navigation within long content items is often a cause of frustration and negatively affects the user experience.

### SUMMARY

The above and other needs are met by a method, computer-readable storage medium, and computer system for analyzing and scoring sections of a digital content item, such as a book, audio track, or video, and then biasing display of sections based on the scores in response to a scrub action performed by the user. The system compiles a user profile, which includes information describing a particular user, such as his/her browsing history, search history, stated interests, and location. The system then identifies or extracts entities from a particular content item, thereby producing an annotation of the content item. The system compares the user profile against a collection of similar user profiles to determine a relevance score for each section of the content item based on information contained in the similar user profiles. The system compares the annotated content item against the user profile to determine another set of relevance scores for each section of the content item. The system compiles an aggregate or total bias score for each section. The system then transmits the bias score to a client device. Responsive to a scrub action performed by a user, a scrubber module of the client device identifies the most relevant sections of the digital content item based on the bias scores. The client device then displays those sections to the user.

Embodiments of the computer-readable storage medium store computer-executable instructions for performing the steps described above. Embodiments of the computer system further comprise a processor for executing the computer-executable instructions.

### BRIEF DESCRIPTION OF DRAWINGS

FIG. 1 is a block diagram illustrating the environment of a digital content platform, including a digital content server and multiple client devices, according to one embodiment.

FIG. 2 is a block diagram illustrating a scrubber biasing module, according to one embodiment.

FIG. 3 is a flowchart describing a method for generating relevance scores for sections of a digital content item for display during media scrubbing, according to one embodiment.

FIG. 4 is a block diagram illustrating a scrubber module on a client device, according to one embodiment.

FIG. 5 is a flowchart describing a method for biasing display of sections of a digital content item during user scrubbing, according to one embodiment.

FIG. 6 is a block diagram illustrating an example of a computer for use as a data server, a processing server, and/or a client, in accordance with one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

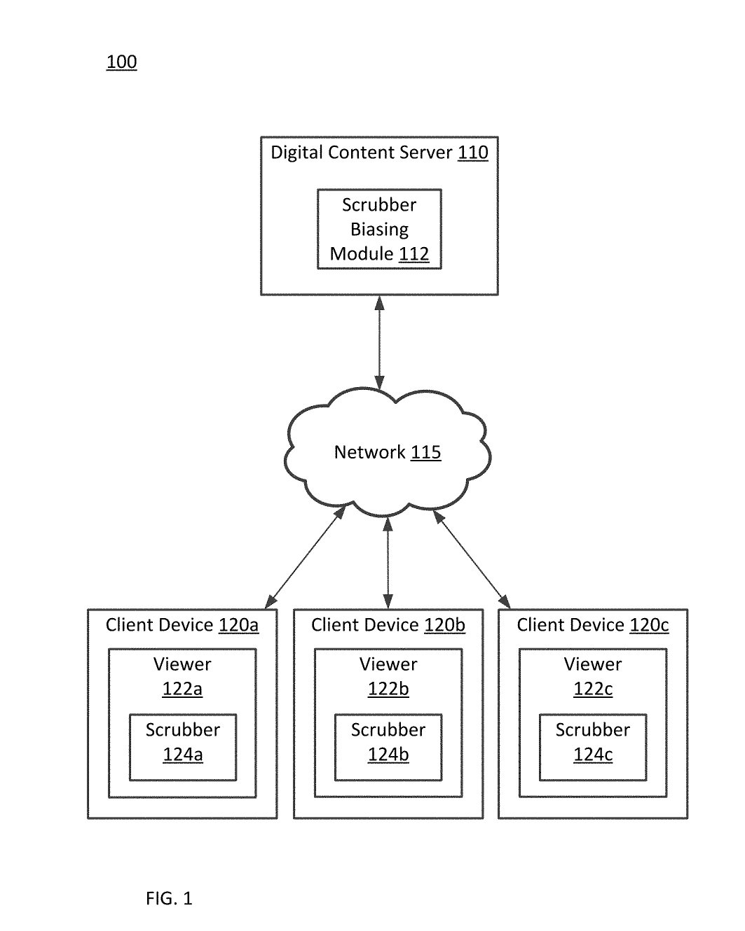

FIG. 1 is a block diagram illustrating the environment of a digital content platform, including a digital content server and multiple client devices, according to one embodiment. The environment 100 includes a digital content server 110 and client devices 120 connected by a network 115. Only three client devices 120a, 120b, and 120c, are shown in FIG. 1 to simplify and clarify the description. Embodiments of the computing environment 100 can have thousands or millions of client devices 120, as well as multiple digital content servers 110.

The client device 120 is a computer or other electronic device used by one or more users to perform activities including browsing, selecting, and viewing digital content (including electronic documents or e-books) received from the digital content server 110. The client device 120, for example, can be a personal computer executing a viewer application 122 that allows the user to view and browse through digital content available from the digital content server 110. In other embodiments, the client device 120 is a network-capable device other than a computer, such as a table computer, personal digital assistant (PDA), a mobile telephone (including for example, a smart phone), a pager, a television set-top box, etc. The client device 120 can display the digital content in a number of ways depending on its type. If, for example, the content is an electronic document (or “e-book”), the content may be displayed in a manner that simulates a physical document. The user can view one page at a time or facing pages. The document may also be displayed as a continuous “page” where the user just scrolls down while reading until the end of the document is reached. The viewer 122 includes a scrubber 124 that allows a user to navigate through the digital content being displayed on the viewer 122. Using the scrubber 124, the user may move forward and backward through the digital content being displayed.

The digital content server 110 is configured to organize and provide digital content items to a client device 120 via the network 115. Digital content items are composed of one or more sections. For example, each page of an e-book or each frame of a video may constitute a section. In practice, a section is associated with a particular offset, which indicates a discrete location within a media file. The digital content server 110 further receives requests for digital content transmitted by the client device 120. The digital content server 110 includes a scrubber biasing module 112. The scrubber biasing module 112 is configured to provide biasing information to the client device 120. Biasing information is used during scrubbing to influence the selection and display of sections of a digital content item that are considered more relevant. Biasing information can be expressed in a number of ways. In one embodiment, biasing information includes a quantitative relevance measurement for each section of a content item. For example, each page of an e-book or each frame of a video may be associated with a biasing score.

In one embodiment, the digital content server 110 receives a request from a user of a client device 120 for one or more digital content items. The digital content server 110 transmits the digital content item(s) to the client device 120 via the network 115. At the same time or at some subsequent point in time, the scrubber biasing module 112 transmits to the client devices 120, again via the network 115, biasing information associated with the digital content item(s).

In situations in which the digital content server 110 or client device 120 collects personal information about users, or may make use of personal information, the users may be provided with an opportunity to control whether programs or features collect user information (e.g., information about a user's social network, social actions or activities, profession, a user's preferences, interactions with electronic documents (as discussed in greater detail below) or a user's current location), or to control whether and/or how to receive content from the digital content server 110 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the digital content server 110 and client device 120.

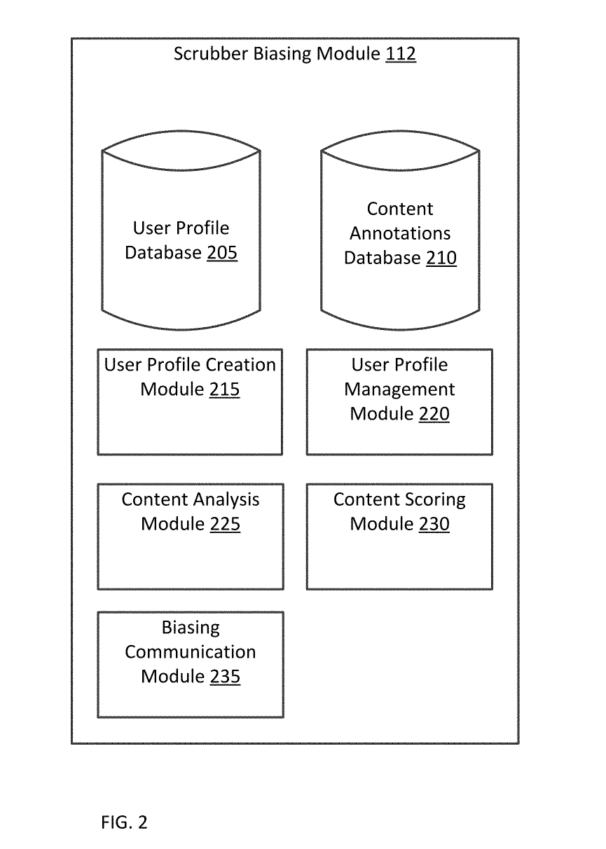

FIG. 2 is a block diagram illustrating a scrubber biasing module, according to one embodiment. The scrubber biasing module 112 features a profile creation module 215. The profile creation module 215 is configured to compile a user profile. In one embodiment, each user profile includes information describing the user as well as his/her browsing habits, such as his/her search history, reading history, browsing history, and current location. Information included in the user profile may be both quantitative and qualitative in nature. In some embodiments, the user profile is further configured to express the recency of information contained therein. In some embodiments, the user profile creation module 215 processes user information to produce an entirely quantitative representation of the user, expressed in the form of an n-dimensional vector.

The user profile management module 220 maintains and compares user profiles for purposes of identifying similar user profiles and inferring common content preferences between similar user profiles. The user profile management module 220 is configured to determine the level of similarity between a collection of user profiles based on some or all of the information contained in each profile. As described with reference to the user profile creation module 215, if each user profile is expressed as an n-dimensional feature vector, then the user profile management module is able to perform highly efficient vector comparison operations to identify similar user profiles in relation to a subject user profile. In order to do so, the user profile management module 220 may configure a distance threshold, potentially expressed as a vector distance, based on which it identifies a collection of user profiles that are “similar enough” to a given subject user profile. In one embodiment, the user profile management module 220 computes a vector distance between each candidate user profile and the subject user profile. If the resultant vector distance is less than the distance threshold, then the candidate user profile is identified as similar. For each such user profile in the collection of similar user profiles, the user profile management module 220 analyzes the user profile information contained therein to identify common content preferences. In one embodiment, the user profile management module 220 analyzes the browsing history and search history included in the similar user profile and determines if the user associated with the similar user profile has, at some point in the past, consumed or interacted with the same digital content item. The user profile management module 220 also analyzes other elements of the user profile, such as location history and stated interests, and synthesizes them to provide a context for each interaction. In some embodiments, an interaction constitutes an instance in which the similar user viewed or read the same digital content item under consideration by the target user. The context of the interaction as synthesized by the user profile management module 220 might include the location, time or day, or frequency at which the user interacted with the digital content item. For example, the similar user may have read the same e-book or watched the same film in the same geographical area of the target user. As part of this analysis, the user profile management module 220 may take into account the recency of information contained in each user profile. Thus, a user profile that contains old or outdated information may have a relatively limited impact on the relevance scores of the sections of a particular content item. Based on previous interactions between one or more similar users and the digital content item, as well as the context associated with each interaction, the user profile management module 220 identifies one or more sections of the digital content item that are likely to be of increased relevance to the target user. Based on which section or sections of the digital content item are identified as more relevant, the user profile management module 220 produces a relevance score for each section.

In practice, the mechanics of comparing a target user profile against a collection of similar user profiles may vary depending on the nature of the content item being consumed. As one illustrative example, if the user associated with the target user profile is watching a particular movie, the user profile management module 220 may analyze the collection of similar profiles to determine that some of the users associated with the similar profiles also viewed the same movie at some point in the past. The user profile management module 220 may extract browsing information from these user profiles which indicate that certain scenes of the movie are of particular importance. This determination could be made based on the fact that multiple users returned to and re-watched some or all of these scenes. The user profile management module 220 could therefore identify these scenes as being of elevated relevance to the target user profile. When the user next scrubs through the movie, the scrubber 124 biases those important scenes for display, making it easier for the user to navigate to the key points of the movie.

As another example, a multi-country travel guide may contain multiple chapters, each corresponding to a particular European city. If the user associated with the target user profile is browsing through the book, the user profile management module 220 may first note the current geographical location of the user. The user profile management module 220 may then compile a collection of similar user profiles, each profile having a geographical association with the current location of the target user. The user profile management module 220 may then analyze these profiles to determine which, if any of them, indicate that the associated users previously used or read the same travel guide. For each user profile, the module 220 may be able to determine which page or pages of the travel guide were most frequently used. The user profile management 220 may then bias display of these pages to the target user, making it easier for the user to find information relevant to his/her current location.

In order to compile and analyze collections of similar user profiles, the scrubber biasing module 112 includes a user profile database 205. The user profile database 205 is configured to organize and store user profiles. The user profile database 205 interacts with both the user profile creation module 215 and the user profile management module 220. The sophistication of the user profile database 205 may vary. In one embodiment, the database 205 performs basic profile retrieval in response to requests received from the user profile creation module 215 or the user profile management module 220. In another embodiment, the database 205 is configured to perform complex profile searching and analysis.

The scrubber biasing module 112 includes a content analysis module 225, which is configured to analyze individual digital content items for purposes of determining relevance to a target user profile. In one embodiment, the content analysis module 225 analyzes each section of a digital content item to identify (or extract) one or more entities. An entity describes a person, place, object, activity, or other semantic unit. The content analysis module 225 annotates each section of a digital content item by creating a layer of metadata which describes the identified entities. The mode of entity extraction can vary depending on the nature of the content item. In the case of an electronic book (“e-book”), the content analysis module 225 identifies at least one entity in the text or images of each page. In the case of a video or audio track, the content analysis module performs entity extraction on a transcription, perhaps produced by a speech recognition engine, associated with the digital content item (if one is available). In some embodiments, the content analysis module may apply an image recognition algorithm to identify text and image entities from still frames of a video. The metadata produced by the content analysis module 225 may be organized by frame or track. The scrubber biasing module 112 further includes a content annotations database 210 which is configured to organize and store content annotations and/or metadata produced by the content analysis module 225.

The content analysis module 225 is configured to compare an annotated digital content item against a target user profile in order to determine the relative relevance of each section of the digital content item to the user. In one embodiment, the content analysis module 225 identifies one or more entities shared between the annotated digital content item and elements of the target user profile. For example, the target user profile may contain items of interest to the user that match or are similar to entities present in the digital content item. Typically, the content analysis module 225 analyzes some or all of the target user profile to determine the relevance of each section of the digital content item. Based on the quality and/or quantity of matched entities, the content analysis module 225 produces a relevance score for each section of a digital content item.

For example, if the content item under analysis is the European travel guide described previously, the content analysis module 225 may analyze the target user profile to determine items of interest to the user. In one example, the user profile may contain information indicating that the user is interested in modern art. The content analysis module 225 may then analyze each page of the travel guide to determine which page or pages contain entities related to art museums. These pages are accordingly marked as more relevant. When the user subsequently flips through the pages of travel guide, these relevant pages are biased for display.

Scoring information produced by the user profile management module 220 and content analysis module 225 are synthesized to produce aggregate relevance scores for a given digital content item. The scrubber biasing module 112 includes a content scoring module 230 which is configured to combine relevance scores. In one embodiment, the content scoring module receives as input from each of the modules 220 and 225 a series of quantitative relevance scores. Accordingly, the content scoring module 230 computes a relatively efficient mathematical average and outputs a combined or total bias score for each section of the digital content item. In other embodiments, some of the relevance information may not be strictly quantitative and instead may include qualitative elements. The content scoring module 230 is then configured to quantify or combine this information in order to produce a combined relevance score for each section of the digital content item. The scrubber biasing module 112 includes a biasing communication module 235 which is configured to receive combined or aggregate relevance scores and transmit them to the client device 120. In one embodiment, the biasing communication module 235 transmits the scoring information as is, without performing any substantive modification on the content or format of the information. In another embodiment, the biasing communication module 235 performs one or more processing steps, such as encryption and/or compression.

The scrubber biasing module 122 may retrieve bias scores for content items, according to the technique described above, in real-time—usually in response to a request from a client device 120 for provision of a particular digital content item. Alternatively, the scrubber biasing module 112 may request and store biasing scores asynchronously and simply retrieve and provide them to a client device 120 when requested.

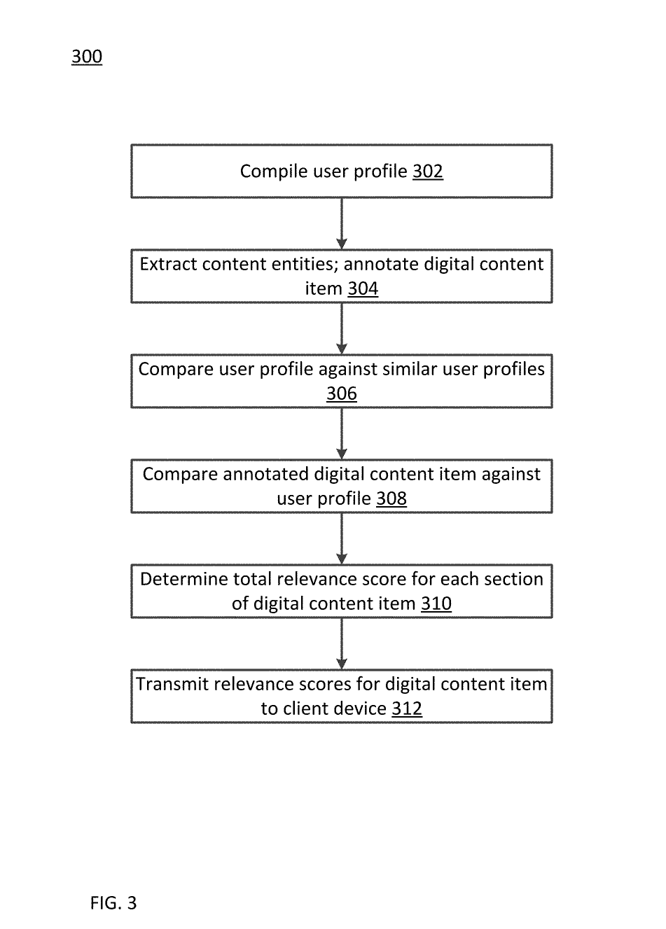

FIG. 3 is a flowchart describing a method for generating bias scores for sections of a digital content item for use during user scrubbing, according to one embodiment. The scrubber biasing module 112 compiles 302 a user profile. The module 112 then extracts 304 one or more content entities from the digital content item. The module 112 compares 306 the target user profile with a collection of similar user profiles in order to identify the likely relevance (to the user) of each section of the digital content item based on similarities between the target user profile and the identified similar user profiles. The module 112 then compares 308 the annotated digital content item, which includes one or more extracted entities, to the user profile to determine the likely relevance of each section. Based on relevance scores derived from the annotated content item and from comparison with similar user profiles, the module 112 determines 310 a total relevance score for each section of the digital content item. The module 112 transmits 312 the relevance scores for the digital content item to the client device.

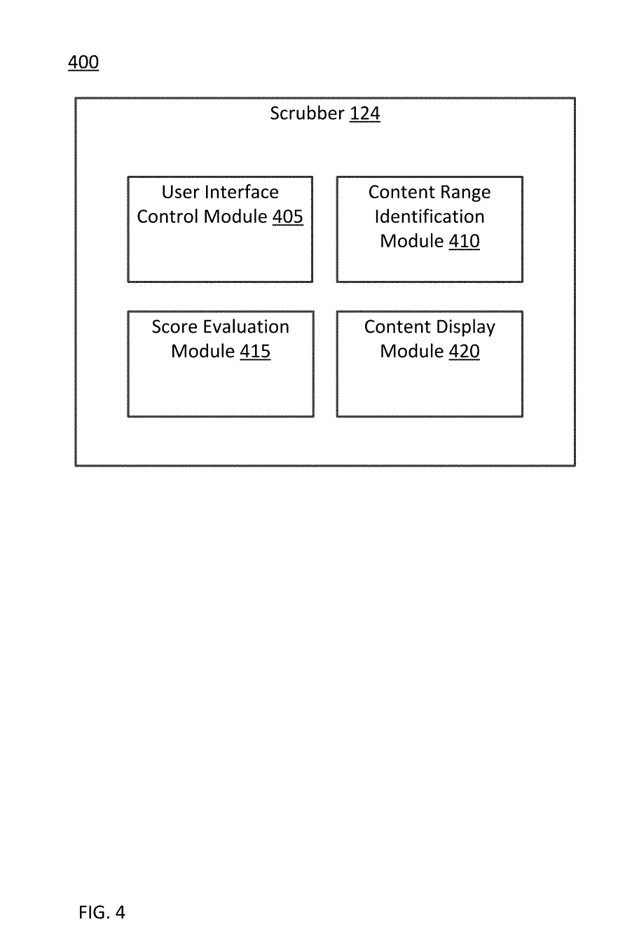

As described with reference to FIG. 1, the client device 120 requests and receives content items from the digital content server 110. The scrubber biasing module 112 produces biasing scores corresponding to the provided content items for use by the client device 120. The scrubber 124 of the client device 120 is configured to utilize received bias scores in order to bias display of sections of a content item during a user scrub action. FIG. 4 is a block diagram illustrating a scrubber module on a client device, according to one embodiment. The environment 400 includes the scrubber module 124. The scrubber module 124 includes a user interface control module 405, which is configured to receive and process scrubbing input from a user of the scrubber 124. In one embodiment, user input may take the form of a button press (such as a fast-forward or rewind button) or a touch-and-drag action (on a touch-sensitive display). The scrubber module 124 also includes a content range identification module 410, which receives user input information conveyed by the user interface control module 405. The content range identification module 410 is configured to process the received user input information and determine the content range desired by the user. For example, if the user is browsing through an e-book on the viewer 122 and fast-forwards or jumps ahead, the content range identification module 410 determines which section of the e-book is the intended destination of the user. Typically, the content range may be expressed as a set of pages. The content range identification module 410 transmits the determined content range to a score evaluation module 415. The score evaluation module 415 retrieves, for each discrete section of the determined content range, a biasing score. As described with reference to FIG. 2, biasing scores are transmitted by the biasing communication module 235 to the client device 120. Biasing scores may be transmitted in real-time, when a user is browsing through a particular digital content item, or at some time prior. Accordingly, the score evaluation module 415 may retrieve the biasing scores from a database or memory unit. Based on an analysis of the biasing scores, the score evaluation module 415 determines a discrete section of the determined content range that has the highest biasing score. In one embodiment, the score evaluation module 415 may identify a single section. In another embodiment, the score evaluation module 415 may identify a handful of sections associated with the highest biasing scores. The score evaluation module 415 transmits an identification of the highest-scoring section or sections to a content display module 420. The content display module 420 displays to the user the discrete section or sections of the content identified by the score evaluation module 415.

The modules included in the scrubber 124 and described above with reference to FIG. 4 may be configured to perform biasing dynamically in response to different types of scrub actions performed by the user. For example, in one embodiment, a user may perform a prolonged scrub action in which he/she holds down a fast-forward button or slowly drags a scrubber bar through a digital content item. In this situation, the user interface control module 405 identifies the scrub action as being prolonged or continuous. It conveys this to the content range identification module, which will responsively produce and continually update a destination content range. Therefore, the destination content range at a time t₁ may differ from the destination content range at a subsequent time t₂. For each such destination content range, the score evaluation module 415 retrieves bias scores for each discrete section of the digital content item contained therein. It provides an identification of the highest scoring section or sections to the content display module 420, which subsequently displays them to the user. In this way, the scrubber module 124 continually displays biased content sections to the user as he/she scrubs through the digital content item.

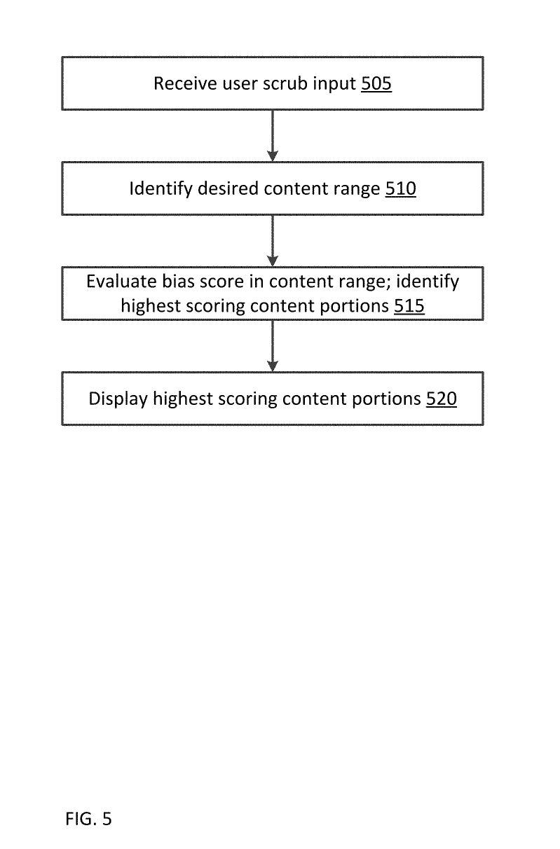

FIG. 5 is a flowchart describing a method for biasing display of sections of a digital content item during user scrubbing, according to one embodiment. The scrubber 124 first receives 505 scrub input from a user, typically in the form of a button press or touch-and-drag action. The scrubber then identifies 510 the desired content range, which includes at least one discrete section of the digital content item. The scrubber then evaluates 515 bias scores for each discrete section in the content range and identifies one or more highest-scoring sections. Finally, the scrubber displays 520 the highest scoring content sections.

In some embodiments, the client device 120 may include a robust computing platform capable of producing biasing scores locally. In this situation, the scrubber module 120 receives a request from a client device 120 for a digital content item. The client device 120 may identify itself as having an enhanced computational ability. As described previously, the scrubber biasing module 112 identifies similar user profiles for a target user profile and analyzes them to determine one or more previous interactions based on the search history, browsing history, or stated interests of the similar users. The scrubber biasing module 112 also identifies entities from a given digital content item. Responsive to the indication from the client device 120, the scrubber biasing module 112 transmits the identified interactions and entities as signals to the client device 120. The client device 120 processes and synthesizes these signals to produce bias scores for consumption by the scrubber 124.

The use of biasing scores by the client device 120 to improve scrubbing performance may cause a decrease in the amount and duration of scrub actions performed by users. Because users are more likely to find the intended section of a content item on the first try, they are less likely to “jump around”. In some embodiments, the resultant decrease in user activity has the effect of extending the battery life of the client device 120. This is particularly desirable when the client device 120 is a smartphone or other mobile device, which typically have limited battery reserves.

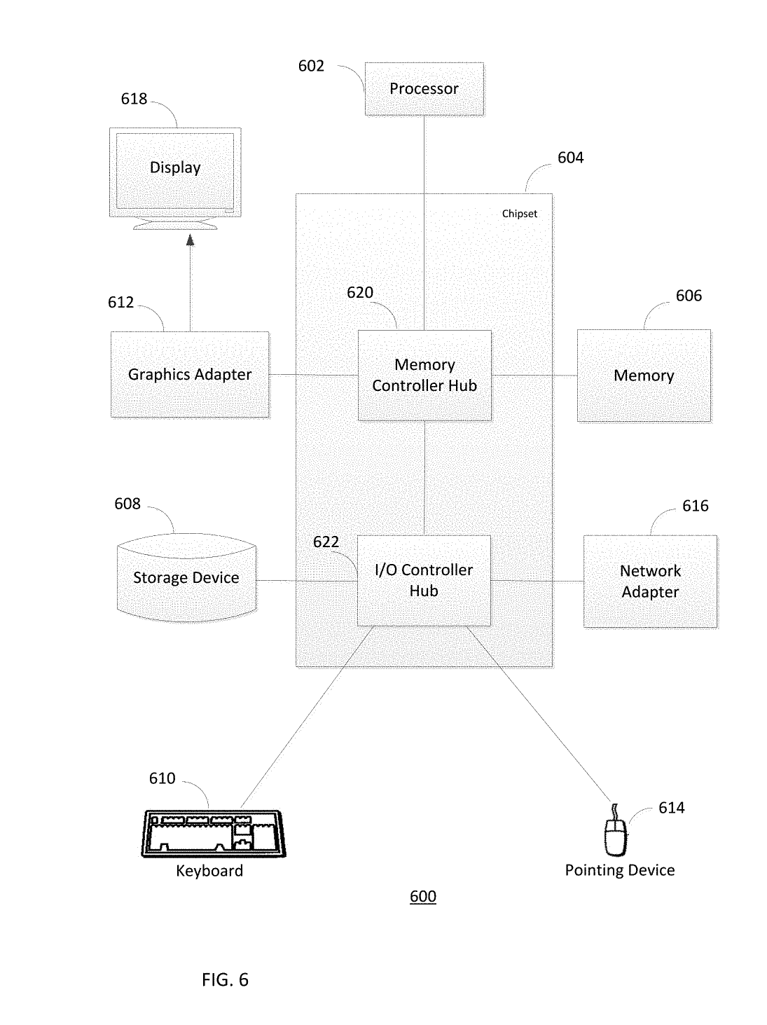

FIG. 6 is a block diagram illustrating an example of a computer for use as a data server, a processing server, and/or a client, in accordance with one embodiment. Illustrated are at least one processor 602 coupled to a chipset 604. The chipset 604 includes a memory controller hub 620 and an input/output (I/O) controller hub 622. A memory 606 and a graphics adapter 612 are coupled to the memory controller hub 620, and a display device 618 is coupled to the graphics adapter 612. A storage device 608, keyboard 610, pointing device 614, and network adapter 616 are coupled to the I/O controller hub 622. Other embodiments of the computer 600 have different architectures. For example, the memory 606 is directly coupled to the processor 602 in some embodiments.

The storage device 608 is a computer-readable storage medium such as a hard drive, compact disk read-only memory (CD-ROM), DVD, or a solid-state memory device. The storage device 608 can be local and/or remote from the computer (such as embodied within a storage area network (SAN)). The memory 606 holds instructions and data used by the processor 602. The pointing device 614 is a mouse, track ball, or other type of pointing device, and is used in combination with the keyboard 610 to input data into the computer system 600. The graphics adapter 612 displays images and other information on the display device 618. The network adapter 616 couples the computer system 600 to the network 115. Some embodiments of the computer 600 have different and/or other components than those shown in FIG. 6.

The computer 600 is adapted to execute computer program modules for providing functionality described herein. As used herein, the term “module” refers to computer program instructions and other logic used to provide the specified functionality. Thus, a module can be implemented in hardware, firmware, and/or software. In one embodiment, program modules formed of executable computer program instructions are stored on the storage device 608, loaded into the memory 606, and executed by the processor 602.

The types of computers 600 used by the entities of FIG. 1 can vary depending upon the embodiment and the processing power used by the entity. For example, a client 120 that is a mobile telephone might have limited processing power, and a small viewer 122. A server-class computer such as that used to implement the document browsing server 110 may be formed of multiple blades and lack a keyboard 610, pointing device 614, or display 618.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A computer-implemented method for producing a set of relevance scores for sections of a digital content item based on a target user profile, the method comprising:
compiling a set of relevance signals expressing a potential utility of each section of the digital content item to a target user;
transmitting the set of relevance signals to a client device, the relevance signals indicating a manner of biasing display of sections of the digital content item by the client device during user scrubbing.

2. The method of claim 1, wherein the set of signals is compiled based on analysis of similar users and wherein compiling the set of signals further comprises:
compiling a target user profile associated with a target user;
comparing the target user profile against a plurality of user profiles to identify at least one other similar user profile associated with a similar user;
determining at least one prior interaction between the similar user associated with the other similar user profile and at least one section of the digital content item; and
based on the prior interaction, determining a first relevance score for each section of the digital content item, the first relevance score describing a potential utility of the section to the target user based on the prior interaction between the similar user and the section.

3. The method of claim 2, wherein the target user profile includes at least one of:
a browsing history of the target user;
a search history of the target user;
at least one stated interest of the target user; or
a current location of the user.

4. The method of claim 3, wherein the target user profile further includes a parameter expressing the recentness of information included in the user profile.

5. The method of claim 2, wherein the prior interaction between the at least one other similar user profile and at least one section of the digital content item comprises a user associated with the similar user profile accessing or viewing the section.

6. The method of claim 2, wherein each user profile is expressed quantitatively as a feature vector, and wherein comparing the target user profile against a plurality of user profiles to determine at least one other similar user profile further comprises:
defining a similarity threshold, the threshold expressed as a maximum vector distance;
computing, between the target user profile and each other user profile in the plurality of user profiles, a vector distance;
comparing each computed vector distance against the maximum vector distance; and
if the computed vector distance is less than the maximum vector distance, designating the user profile as a similar user profile.

7. The method of claim 1, wherein the set of signals is compiled based on analysis of the digital content item and wherein compiling the set of signals further comprises:
identifying, for each section of the digital content item, at least one entity;
identifying a match between an element of the target user profile and at least one of the determined entities;
based on the match, determining a second relevance score for each section of the digital content item, the second relevance score describing a potential utility of the section to the target user based on the match between an element of the target user profile and the entity identified in the section; and
determining, for each section, a total relevance score based on the first and second relevance scores, the total relevance score describing a total potential utility of the section to the target user

8. The method of claim 7, wherein an entity describes at least one of:
a person,
a place,
an object, or
an activity.

9. The method of claim 1, wherein a first set of relevance signals and a second set of relevance signals are combined into a third set of aggregate relevance signals.

10. The method of claim 9, wherein combining the first and second sets of relevance signals further comprises weighting the sets based on relative importance.

11. A computer readable medium storing instructions for producing a set of relevance scores for sections of a digital content item based on a target user profile, the instructions when executed causing a processor to:
compile a set of relevance signals expressing a potential utility of each section of the digital content item to a target user;
transmit the set of relevance signals to a client device, the relevance signals indicating a manner of biasing display of sections of the digital content item by the client device during user scrubbing.

12. The computer readable medium of claim 11, wherein the set of signals is compiled based on analysis of similar users and wherein compiling the set of signals further comprises:
compiling a target user profile associated with a target user;
comparing the target user profile against a plurality of user profiles to identify at least one other similar user profile associated with a similar user;
determining at least one prior interaction between the similar user associated with the other similar user profile and at least one section of the digital content item; and
based on the prior interaction, determining a first relevance score for each section of the digital content item, the first relevance score describing a potential utility of the section to the target user based on the prior interaction between the similar user and the section.

13. The computer readable medium of claim 12, wherein the target user profile includes at least one of:
a browsing history of the target user;
a search history of the target user;
at least one stated interest of the target user; or
a current location of the user.

14. The computer readable medium of claim 13, wherein the target user profile further includes a parameter expressing the recentness of information included in the user profile.

15. The computer readable medium of claim 12, wherein the prior interaction between the at least one other similar user profile and at least one section of the digital content item comprises a user associated with the similar user profile accessing or viewing the section.

16. The computer readable medium of claim 12, wherein each user profile is expressed quantitatively as a feature vector, and wherein comparing the target user profile against a plurality of user profiles to determine at least one other similar user profile further comprises:
defining a similarity threshold, the threshold expressed as a maximum vector distance;
computing, between the target user profile and each other user profile in the plurality of user profiles, a vector distance;
comparing each computed vector distance against the maximum vector distance; and
if the computed vector distance is less than the maximum vector distance, designating the user profile as a similar user profile.

17. The computer readable medium of claim 11, wherein the set of signals is compiled based on analysis of the digital content item and wherein compiling the set of signals further comprises:
identifying, for each section of the digital content item, at least one entity;
identifying a match between an element of the target user profile and at least one of the determined entities;
based on the match, determining a second relevance score for each section of the digital content item, the second relevance score describing a potential utility of the section to the target user based on the match between an element of the target user profile and the entity identified in the section; and
determining, for each section, a total relevance score based on the first and second relevance scores, the total relevance score describing a total potential utility of the section to the target user

18. The computer readable medium of claim 17, wherein an entity describes at least one of:
a person,
a place,
an object, or
an activity.

19. The computer readable medium of claim 11, wherein a first set of relevance signals and a second set of relevance signals are combined into a third set of aggregate relevance signals, and wherein combining the first and second set of relevance signals further comprises weighting the sets based on relative importance.

20. A client device comprising:
a viewer;
a scrubber, the scrubber further comprising:
a user interface control module;
a content range identification module;
a score evaluation module; and
a content display module;
the client device further configured to:
detect, via the scrubber, a scrub action being performed by the user during display of a digital content item;
determine a desired content range associated with the scrub action, the desired content range comprising at least one section of the digital content item;
retrieve, for each section identified in the content range, a relevance score corresponding to the section;
based on the at least one relevance score, determine a preferred section, the preferred section associated with a highest relevance score; and
display the preferred section to the user.
